(19) United States
(12) Patent Application Publication
(10) Pub. No.: US 2013/0016215 A1
(43) Pub. Date: Jan. 17, 2013

(54) DAZZLING LASER RIFLE

(71) Applicant: PVB Hodings LLC, Anderson, IN (US)

(72) Inventors: Peter V. Bitar, Anderson, IN (US); Rick Lee Busby, Pendleton, IN (US)

(73) Assignee: PVB Holdings LLC, Anderson, IN (US)

(21) Appl. No.: 13/621,347

(22) Filed: Sep. 17, 2012

Related U.S. Application Data
(63) Continuation of application No. PCT/US2011/028632, filed on Mar. 16, 2011.
(60) Provisional application No. 61/314,381, filed on Mar. 16, 2010.

(51) Int. Cl. F21L 4/00; G06Q 40/08; H01H 9/56; H04N 7/18; G01J 1/42; H05B 37/00

(52) U.S. Cl. 348/143; 362/187; 250/208.2; 315/307; 705/500; 348/E07.085

(57) ABSTRACT

Disclosed is a handheld long range dazzling laser including a 1 Watt or greater laser light source, a focus-adjustable beam expander, a power source, a trigger and a magnifying targeting device. Also disclosed is a method of discounting ship insurance rates based on equipping ships with the disclosed handheld long range dazzling laser.

### CROSS REFERENCE TO RELATED APPLICATIONS

This application is a continuation of International Application No. PCT/US11/28632, filed Mar. 16, 2011. Application No. PCT/US11/28632 claims the benefit of U.S. Provisional Application No. 61/314,381, filed Mar. 16, 2010.

### BACKGROUND

The threat of piracy is growing rapidly, and the potential for escalation of this into full-blown global terrorism is only beginning to be understood. Piracy is causing a major disruption in trade and maritime transit, and is a direct threat to life and property in several parts of the world.

It is generally understood that conventional firearms are not recommended for ships to defend themselves, and though this may change over time, they carry their own risks. Additionally, trained, full-time staff to carry those arms for the purpose of repelling boarders, is a long-term expense that also depends on relatively close engagement with pirates, who are becoming increasingly emboldened and experienced in their attacks.

The use of non-lethal weapons has been proven effective in counter-piracy, specifically the use of sonic/acoustic devices (the LRAD—Long Range Acoustic Device—was used in November, 2005 by a cruise ship, the Seabourn Spirit to great effect in allowing the ship's escape from attack). However, this type of device is relatively short ranged in terms of maritime applications (350 meters truly effective).

The present disclosure concerns long range non-lethal dazzling lasers. One proposed uses of long range non-lethal dazzling lasers is to deter piracy.

### BRIEF DESCRIPTION OF THE DRAWINGS

FIG. 1 is a perspective view of a first embodiment of a dazzling laser rifle.

FIG. 2 is an assembly view of the FIG. 1 dazzling laser rifle.

FIG. 3 is a block diagram of an embodiment of the FIG. 1 dazzling laser rifle.

FIG. 4 is a block diagram of an alternative embodiment of the FIG. 1 dazzling laser rifle.

FIG. 5 is a block diagram of another alternative embodiment of the FIG. 1 dazzling laser rifle.

FIG. 6 is a right side elevational view of a second embodiment of a dazzling laser rifle.

FIG. 7 is a front elevational view of the FIG. 6 dazzling laser rifle.

FIG. 8 is a rear elevational view of the FIG. 6 dazzling laser rifle.

FIG. 9 is a top plan view of the FIG. 6 dazzling laser rifle.

FIG. 10 is a left side view of the FIG. 6 dazzling laser rifle.

FIG. 11 is a perspective view of the FIG. 6 dazzling laser rifle with the upper cover removed.

FIG. 12 is a right side elevational view of the FIG. 11 arrangement.

FIG. 13 is a top plan view of the FIG. 11 arrangement.

FIG. 14 is a side elevational view of a beam expander, a component of the FIG. 6 dazzling laser rifle.

FIG. 15 is a rear perspective view of the FIG. 6 dazzling laser rifle with the video flip screen deployed.

FIG. 16 is an electrical schematic of the FIG. 6 dazzling laser rifle.

FIG. 17 is a bottom perspective view of an alternative embodiment of the FIG. 6 dazzling laser rifle incorporating a key pad.

FIG. 18 is a perspective view of a third embodiment of a dazzling laser rifle incorporating sensors.

FIG. 19 is a top plan view of the FIG. 18 dazzling laser rifle illustrating sensor detection areas.

FIG. 20 is a flow chart illustrating an activation procedure.

FIG. 21 is a block diagram illustrating a first embodiment of the dazzling laser rifle controls.

FIG. 22 is a block diagram illustrating a second embodiment of the dazzling laser rifle controls.

### DETAILED DESCRIPTION

Reference will now be made to certain embodiments and specific language will be used to describe the same. It will nevertheless be understood that no limitation of the scope of this disclosure and the claims is thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

Disclosed herein is a long range non-lethal dazzling laser system proposed as a radical approach to ship protection from the growing piracy threat throughout the world. This disclosed system has a range of in excess of 1 kilometer, which can, in an eye-safe manner, disable the vision of would-be attackers looking toward the defended ship. This puts attackers at a serious disadvantage against the crew of the defending ship. The range of the disclosed system also exceeds the effective range of most small-arms weapons commonly used by pirates, giving a significant advantage to the crew of the defending ship. Furthermore, a ship that at least appears ready to defend itself which has clearly identified the attackers at long range also provides some deterrent to an attack.

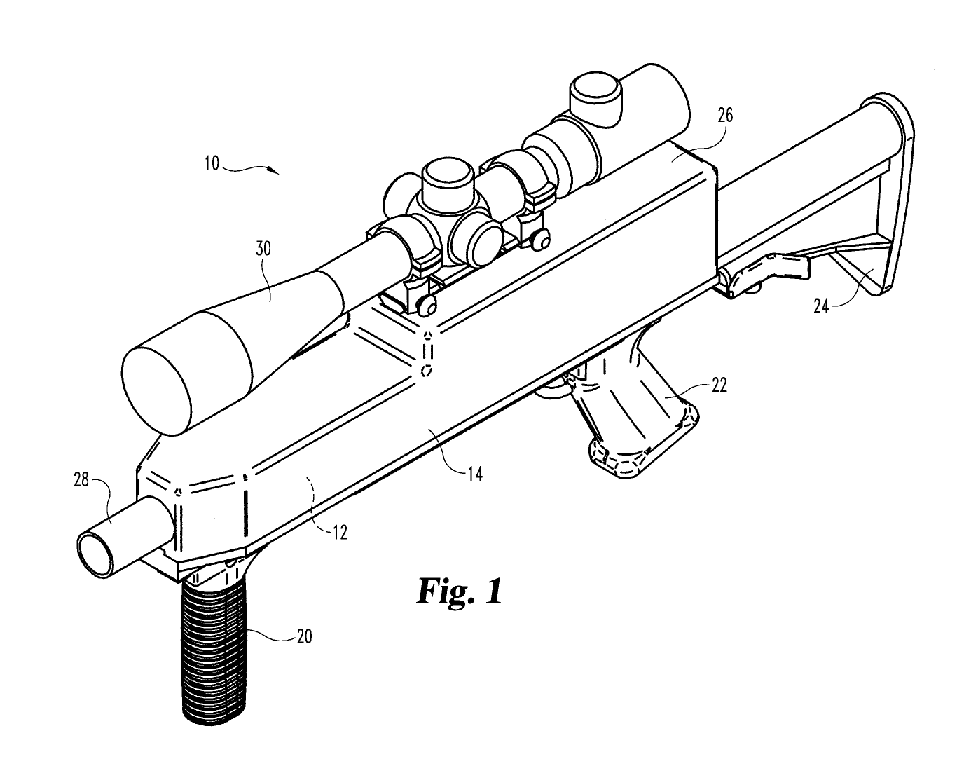

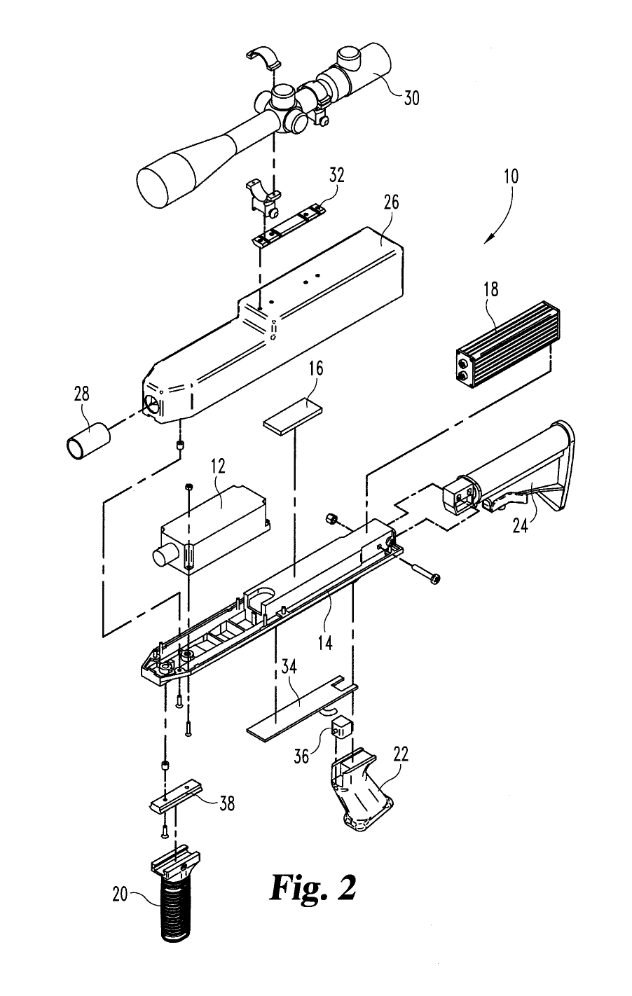

Referring to FIGS. 1 and 2, device 10 is illustrated. Device 10 includes laser light source 12 mounted on frame 14 with circuit board 16 and battery 18. Frame 14 is stabilized for personal use by front handle 20, rear handle 22 and stock 24. Upper cover 26 attaches to frame 24 covering laser light source 12, circuit 16 and battery 18. Lens cover 28 covers the emitting end of laser light source 12 that protrudes from upper cover 26. Scope 30 is mounted on upper cover 26 via mounting rail 32. Lower cover 34 is mounted below frame 14 covering battery 18 (lower cover 34 permits access and removal of battery 18 from frame 14). Trigger switch 36 is incorporated in rear handle 22 and is operably connected to activate laser light source 12. Front handle 20 is mounted on frame 14 by mounting rail 38.

Laser light source 12 can be a relatively powerful laser (Class IV in one embodiment), producing high-intensity visible, coherent light in excess of 1 Watt, up to 10,000 Watts in the visible spectrum from approximately 400-800 nanometers (nm) of wavelength.

In one embodiment, frame 14 also acts as a heat sink extracting heat from laser light source 12 and/or circuit board 16 and/or battery 18. In one embodiment, frame 14 is constructed of aluminum or other highly heat conductive material. In some embodiments (not illustrated), this step may be augmented by one or more fans and/or fin structures to increase convectional heat transfer to surrounding air.

Battery 18 may be in the form of a quick change battery magazine that loads into a magazine receiver in frame 14. Such a quick change battery magazine may lock into place with spring tabs engaging slots (with the tabs on the magazine and the slots on the receiver, or vice versa). In the illustrated embodiment, battery 18 includes two lithium-polymer cells in series making a 7.4V battery with a 6400 mAh capacity and a maximum discharge rate of 20 A.

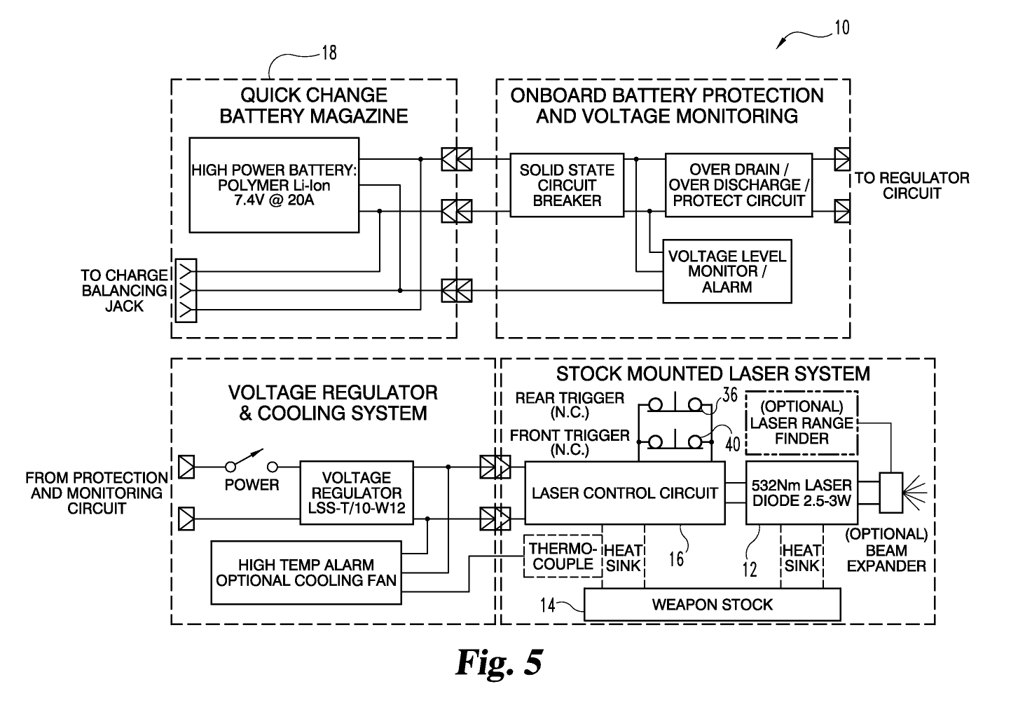

Trigger switch 36 is a normally closed momentary switch. While depressed, trigger switch 36 interrupts a control circuit on circuit board 16, thereby signaling to circuit board 16 to activate laser light source 12. In alternative embodiments (such as illustrated in FIG. 5) an additional trigger switch 40 can be located on front handle 20 with trigger switch 40 wired in parallel with trigger switch 36 so that both trigger switch 36 and 40 have to be actuated to interrupt the control circuit on circuit board 16.

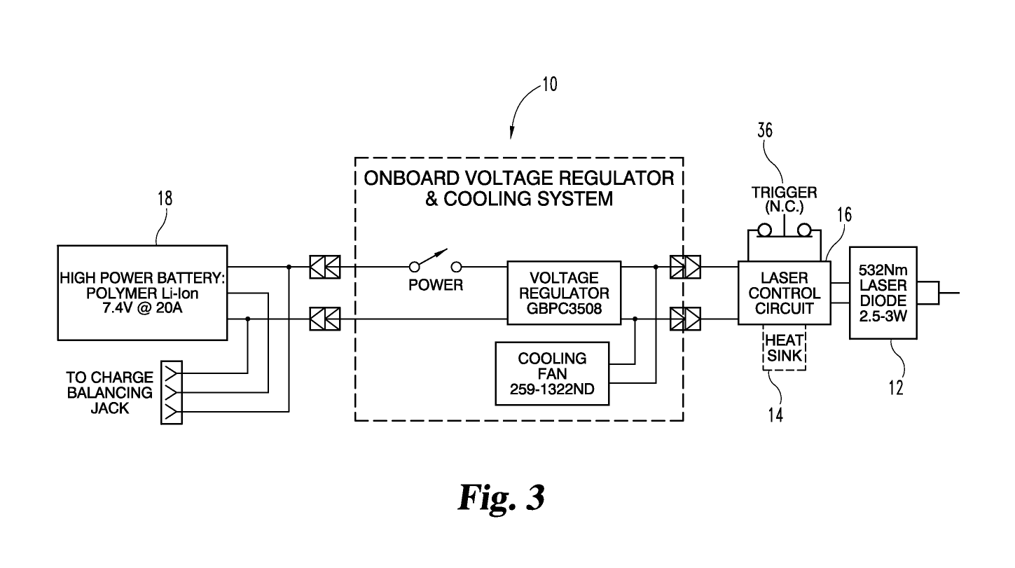

Referring now to FIG. 3, an embodiment of device 10 is illustrated as a block diagram including laser light source 12, laser control circuit 16, frame 14 acting as a heat sink, battery 18 and trigger switch 36. Also illustrated is a voltage regulator that is in the form of a diode bridge positioned between battery 18 and trigger switch 36 as well as a cooling fan that operates to force air flow over laser control circuit 16. In the illustrated embodiment, laser light source 12 emits light in the frequency of 532 nm (green light) with a power of approximately 2.5 to 3 watts. Powering this is a lithium ion high powered polymer battery operating at 7.4 volts and 20 amps.

Laser light source 12 may be a laser diode and an array of laser diodes or any other lasers known in the art. The output laser beam may optionally be routed through an appropriate beam expansion optics such as one or more beam expanders to create a larger spot size. Alternatively, such beam expansion optics can be incorporated directly into laser light source 12. In other embodiments, the output laser light may be spread by rastering laser light source 12 to regulate the average power of light falling upon a particular spot.

Laser light source 12 is used to temporarily flash blind and disorient a target. Temporarily taking away the target's ability to see and lowering the risks associated with that target including providing time to take further step. Laser light source 12 emits a beam of light that is designed to disable but not permanently harm the eye, by maintaining a maximum light density of approximately 26 milliwatts per square centimeter in the impact area. However this is a maximum allowable light density. In other embodiments, laser intensity can range between approximately 2 to approximately 26 milliwatts per square centimeter. Device 10 is configured for long range use, for example, up to 1.5 kilometers distance. For example, in the embodiment illustrated in FIG. 3, laser light source 12 emits a 2.5 watt laser light output that, when expanded at 1 kilometer distance to a 100 cm round spot (approximately 39 inches), has a laser light intensity equal to approximately 2.5 milliwatts per square centimeter (at 1 kilometer). A similar light intensity can be achieved at 1.5 kilometers by refocusing the laser beam expansion to have a 100 cm diameter spot size at 1.5 kilometers.

As will be appreciated, a larger spot size is more easily targeted and can simultaneously affect a greater number of targets while increased laser light intensity may provide greater dazzling effects. Use of larger capacity powers sources and larger capacity laser light sources or multiple laser light sources allows larger and/or more intense spots to be generated at a particular range. Other embodiments (not illustrated) can utilize more powerful power sources to allow use of larger laser light sources to achieve greater power output. For example, separating battery 18 from device 10 and using a larger battery, for example, by mounting battery 18 on a backpack with a cable between the battery and device 10, a more powerful laser light source 12 can be utilized. In yet other embodiments, where a permanent power source is available, for example, a plug in power source, an even more powerful laser light source 12 may be utilized. It will also be appreciated that with a plug in power source it may be necessary to transform a power source to appropriate DC voltage to operate the individual laser light source 10 selected.

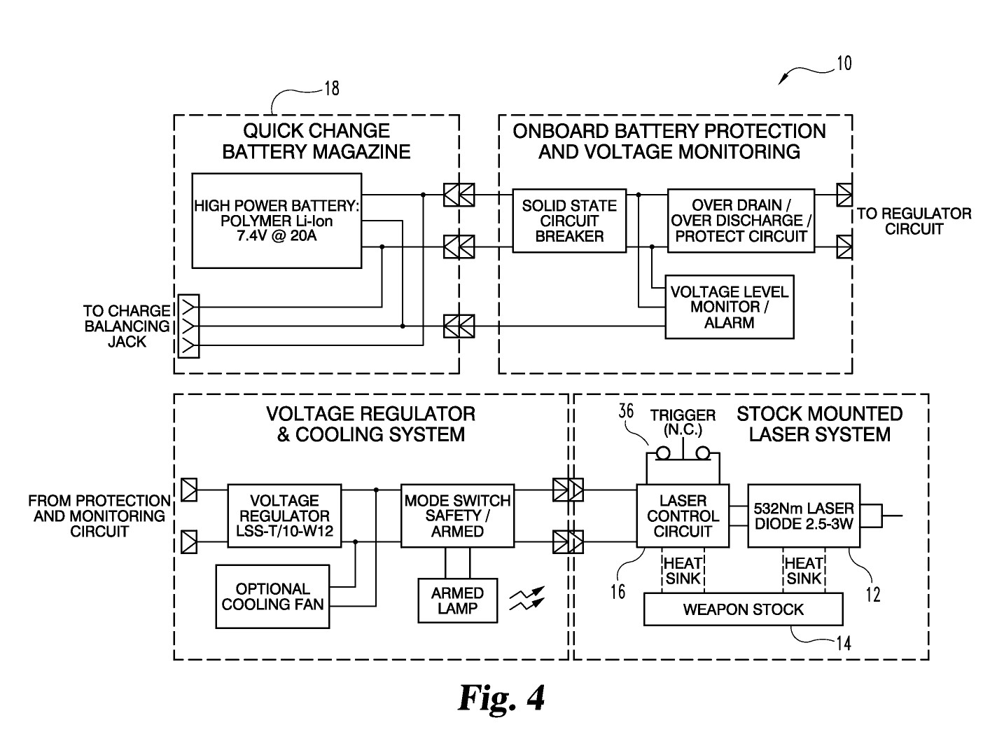

Referring now to FIG. 4, a block diagram of an alternate embodiment is illustrated incorporating battery protection and voltage monitoring between battery 18 and laser control circuit 16. In addition, the embodiment illustrated in FIG. 4 incorporates a safety arming switch that prevents accidental discharge of laser light source 12. The illustrated mode select safety/armed switch takes the form of a power switch. Such a power switch may be positioned wherever desired including within reach of a hand located on the rear handle 22. In one embodiment, actuation of the mode select safety/armed switch activates an armed LED lamp to provide visual feedback to the operator that the device 10 is powered and ready for use.

The Onboard Battery Protection and Voltage Monitoring Circuit can be mounted in the upper housing of the stock. Current limiters can be used as solid state circuit breakers to limit the current draw on the batteries to 15 A. If the limiters are tripped, the Power switch must be turned off until the limiters cool down and reset.

The voltage level monitor/alarm monitors the voltage of each cell. When either cell drops below the set point, generally above the lowest voltage recommended by the battery manufacturer, the circuit blinks the Power LED warning the battery should be changed. The over drain/over discharge/protect circuit is configured to prevent laser light source 12 from draining current at too high of a rate and will interrupt the voltage supply to laser light source 12 in the event the battery voltage level reaches the manufacturer's recommended low limit. It is redundant to the current limiters and can be configured to interrupt power to the load after identifying a low voltage.

Referring to FIG. 5, a block diagram of an alternate embodiment is illustrated incorporating a high temperature alarm, a laser range finder and a beam expander. The illustrated beam expander can be an adjustable beam expander to vary the spot size of the emitted laser light. Control of the adjustable beam expander can be linked to a laser range finder with a controller to maintain the emitted laser intensity (at range) at the desired light density. The desired light density can be programmed or can be adjustable while maintaining the emitted laser intensity (at range) below an allowable maximum light density and above a minimum light density.

The Voltage Regulation and Cooling System can be mounted to frame 14. The Power switch acts as an electrical safety for device 10. Once turned on, the voltage regulator maintains a steady 6 Vdc supply to the Trigger switch. The high temperature alarm circuit utilizes feedback from a thermocouple to monitor the temperature of the laser control circuit. If the circuit overheats, an LED will light to indicate the system should shutdown. The optional cooling fan can be used to delay or prevent catastrophic overheating.

One application for device 10 is as a non-lethal, but effective, deterrent to pirates approaching ships on the high seas. Device 10 can be utilized to interrogate pirates at long range, outside of normal small arms weapons ranges, with bright laser light potentially causing the following effects: (1) Complete “cloaking” of the ship from the Pirate's perspective, making the ship disappear by virtue of the fact that all the pirates see is the laser light coming from that direction. (2) Eye-safe, temporary visual impairment of the pirates. (3) Secondary effects like headaches, nausea, and disorientation the longer they attempt to “look through” the beam toward the ship. (4) Delay, as any move made by the pirates to avoid the beam buys time for the defending ship to evade. (5) General deterrent if the laser is interpreted by the pirates as a targeting laser for something more deadly, such as a laser designated rocket. (6) General deterrent from targeting a ship with device 10 on board, i.e., they may look for easier prey.

Device 10 can also be utilized in other environments and for other purposes, for example, on land, in ports, at borders, for perimeter security or other applications where long standoff distances for the described capabilities provided by device 10 may be desired.

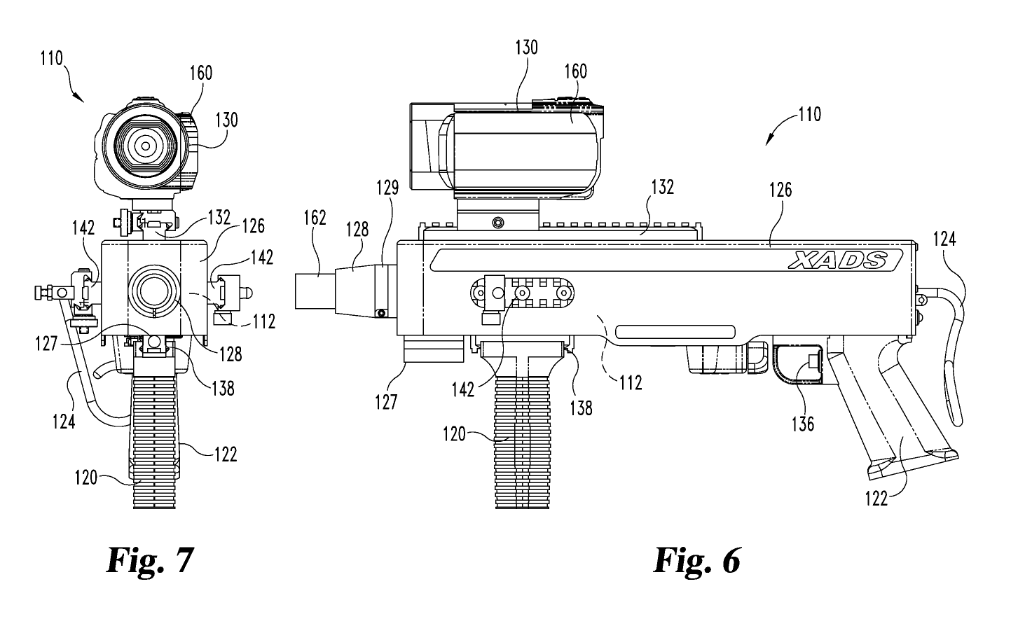

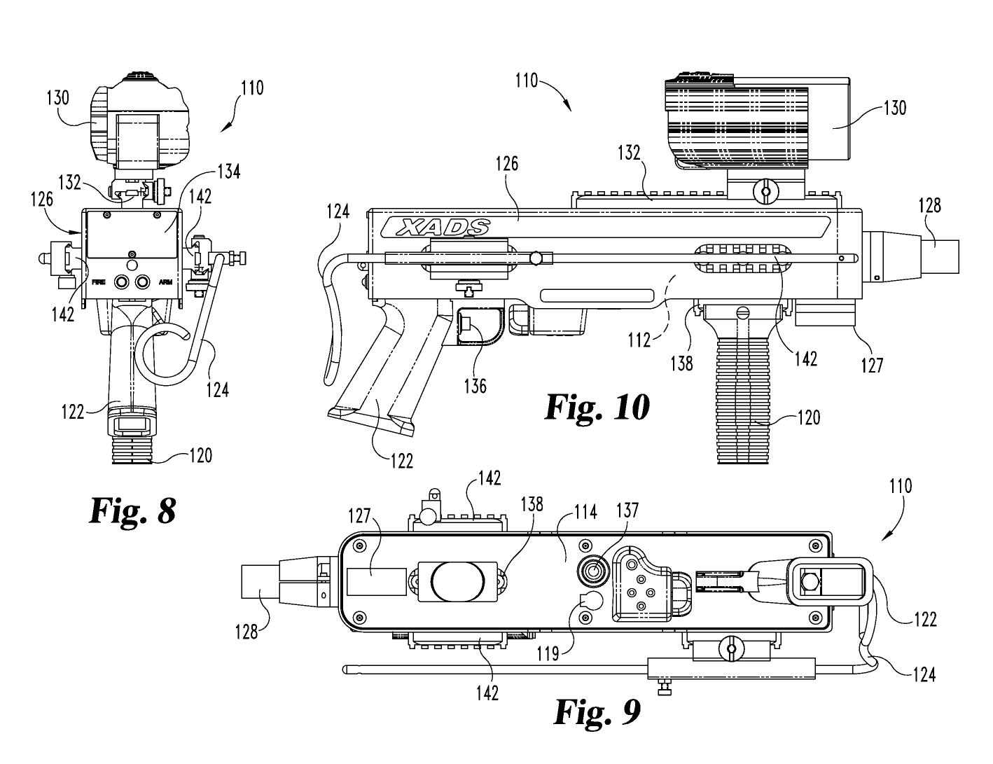

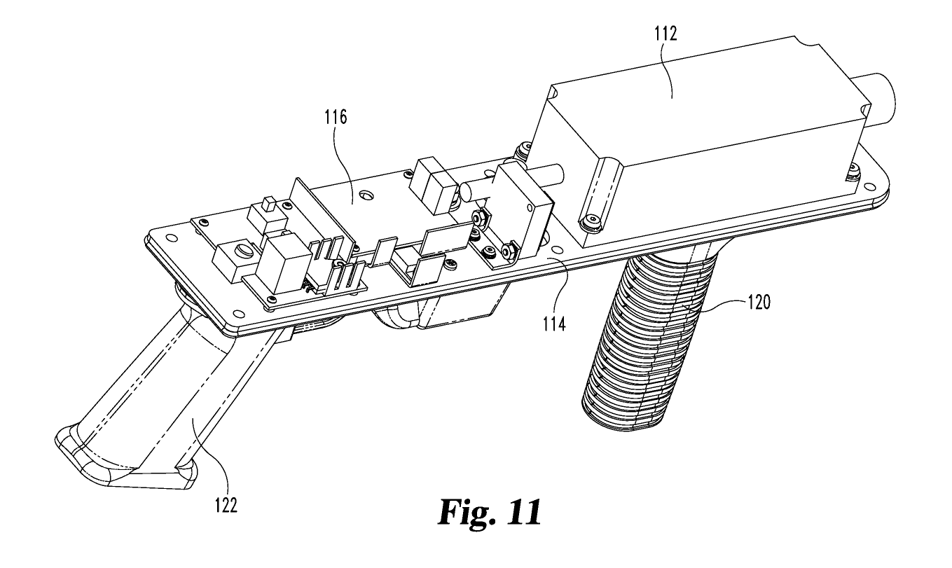

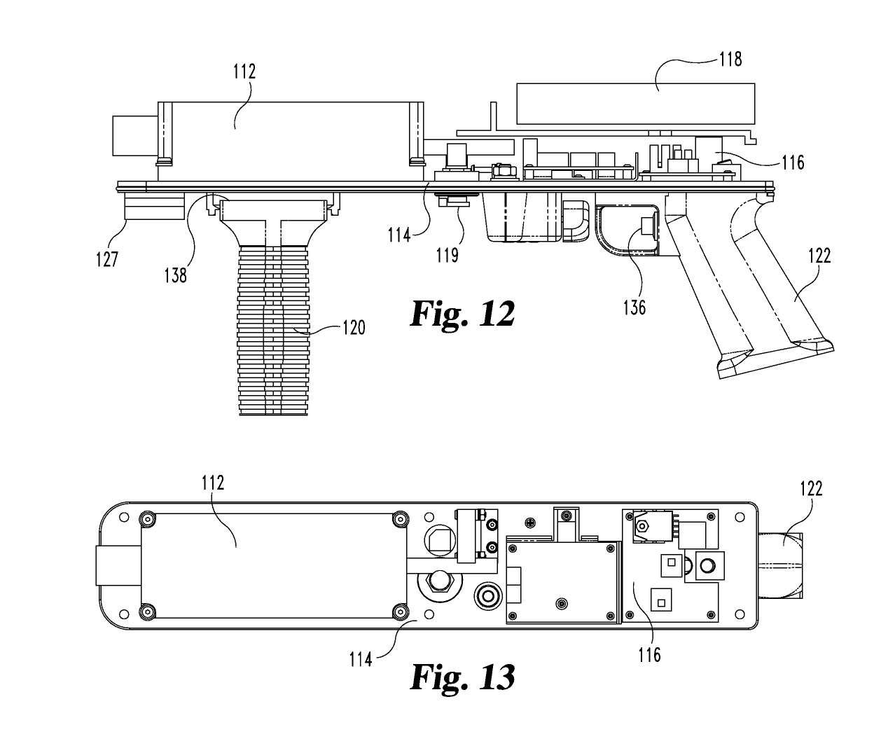

Referring to FIGS. 6-13, device 110 is illustrated. Device 110 includes laser light source 112 mounted on frame 114 with circuit board 116 and battery 118. Frame 114 is stabilized for personal use by front handle 120, rear handle 122 and stock 124. Upper cover 126 attaches to frame 124 covering laser light source 112, circuit board 116 and battery 118. Device 110 also includes beam expander 128, range finder 127, camera 130, arming switch 137 and charging port 119.

Beam expander 128 covers the emitting end of laser light source 112 that protrudes from upper cover 126. Beam expander 128 expands the diameter of the laser light emitted by source 112 and provides a focusing mechanism that can diverge the laser light to create a larger (or smaller) emitted spot size. The illustrated embodiment utilizes a Model EXP0532-4X GEOMATEC™ brand Fixed Ratio 532 nm Compact Beam Expander with Focus available from BeamExpander.com LLC, Canton, Mass., USA, Tel: 781-255-1063 and available at beamexpander.com.

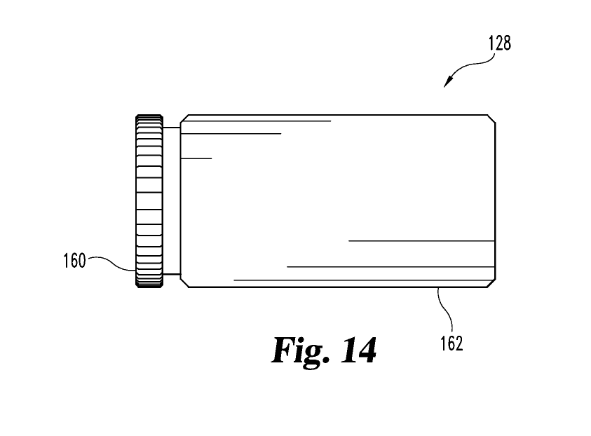

As shown in FIG. 14 beam expander 128 includes base 160 and body 162 that is rotatable with respect to base 160 to vary the divergence of the emitted laser light. As shown in FIG. 6, clamp 129 affixes base 160 to upper cover 126 leaving body 162 accessible to be rotated to adjust the divergence of the emitted laser light. While not illustrated, beam expander 128 may optionally be modified by adding a physical block between base 160 and body 162 to provide a lower limit to the divergence rate.

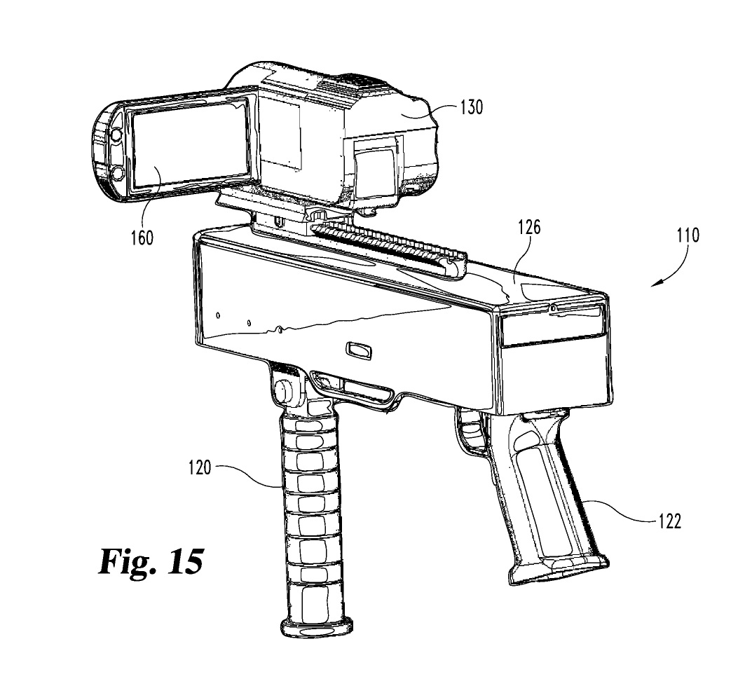

Camera 130 is mounted on upper cover 126 via mounting rail 132. As shown in FIG. 15, camera 130 is a digital camera with an optical zoom and display screen 160. The optical axis of camera 130 is aligned with the optical axis of beam expander 128 so that display screen 160 can be used for targeting. Camera 130 can also be utilized to record the results of activating device 110. Camera 130 includes a storage means (not illustrated) to record pictures and/or video from camera 130. In the illustrated embodiments, camera 130 is long range zoom video recorder with a flip-up screen and a video transmitter (not illustrated) operable to transmit live video to a remote location.

Range finder 127 is mounted to the underside of frame 114 in the front of device 110. Range finder 127 is operable to determine the range to a target. The optical axis of range finder 127 is aligned with the optical axis of beam expander 128 so that range finder 127 indicates the distance to the target shown in display screen 160 (or the target visible through scope 30 in device 10).

Battery cover 134 is mounted on the rear face of upper cover 126 and provides access to an interior space holding battery 118 (battery cover 134 permits access and removal of battery 118 from inside upper cover 126 without removing upper cover 126). In the illustrated embodiment, battery 118 includes two lithium-polymer cells in series making a 7.4V battery with a 6400 mAh capacity and a maximum discharge rate of 20 A. Battery 118 can be charged by plugging a recharger into charging port 119 or battery 118 can be manually exchanged through battery cover 134.

Arming switch 137 is incorporated into frame 114. Arming switch 137 controls power to device 110.

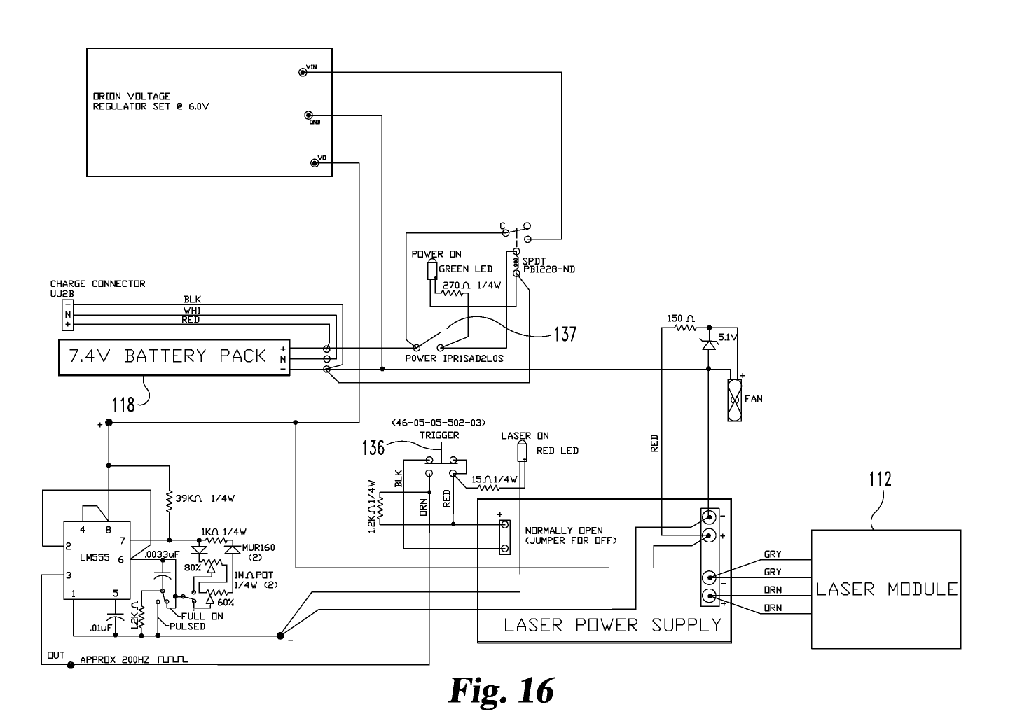

Trigger switch 136 is incorporated in rear handle 122 and is operably connected to activate laser light source 112. Front handle 120 is mounted on frame 114 by mounting rail 138. Trigger switch 136 is a normally closed momentary switch. While depressed, trigger switch 136 interrupts a control circuit on circuit board 116, thereby signaling to circuit board 116 to activate laser light source 112. Referring to FIG. 16, an electrical schematic of device 110 is provided.

In the illustrated embodiment, laser light source 112 is a 3 Watt Class IV laser that produces high-intensity visible, coherent light in the visible spectrum at approximately 532 nm of wavelength (green). In other embodiments laser light source 112 could vary between approximately 1 and 10,000 Watts.

In the illustrated embodiment, frame 114 is configured and arranged to act as a heat sink extracting heat from laser light source 112 and circuit board. Frame 114 is constructed of aluminum or other highly heat conductive material. In the illustrated embodiment, this step is augmented by a fan (not illustrated) located inside upper cover 126 to increase convectional heat transfer to surrounding air.

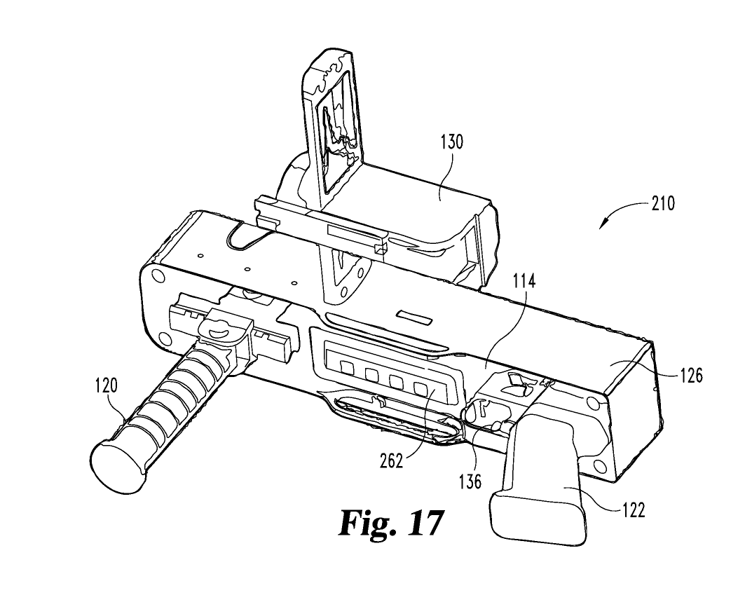

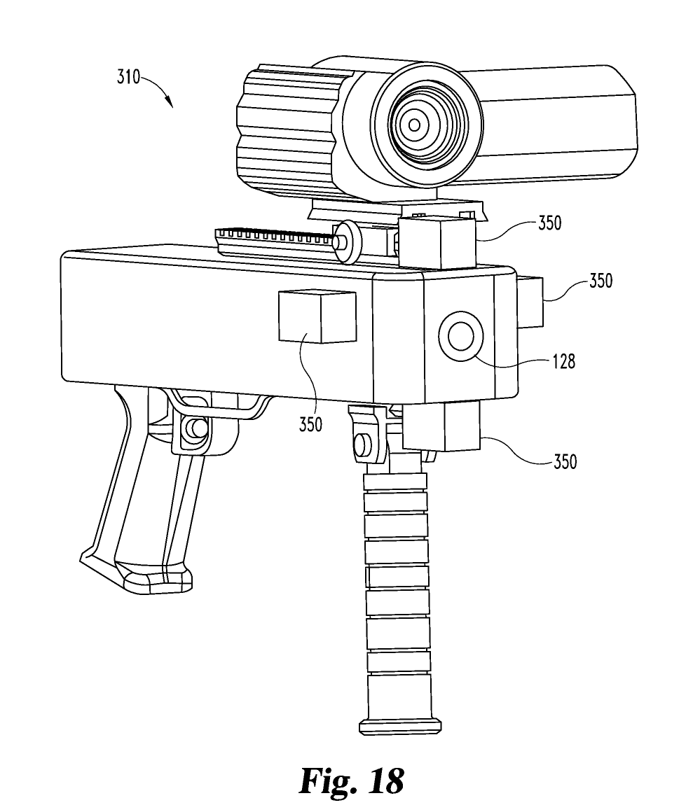

Referring to FIG. 17, device 210 is illustrated incorporating keypad 262 on frame 114. In device 210, keypad 262 replaces arming switch 137 from device 110. Keypad 262 is used to prevent unauthorized use of device 210 by requiring operators to enter a unique access code prior to activating device 210. In one embodiment, entering a correct code would activate the systems in device 210 for a set length of time, for example, 15 minutes, in which device 210 would operate by depressing trigger switch 136. After the set length of time, device 210 would be deactivated until reactivated by entry of a proper activation code. This would prevent use by unauthorized persons.

In alternative embodiments (not illustrated), other biometric readers could be used for authorization, including, but not limited to, fingerprint, voiceprint or retinal readers. In yet other embodiments, activation of devices 110 or 210 could be remotely controlled, for example, in the bridge of a ship or in a secured control center. Real time video transmitted from camera 130 could also be transmitted to the bridge or secured control center to provide situation information to the individual tasked with authorizing use of device 110 or 210.

Referring to FIG. 18, device 310 is illustrated. Device 310 incorporates detectors 350 mounted around the forward end of device 310. In one embodiment, detectors 350 are ultrasonic sensors configured to detect the presence of objects within a defined area.

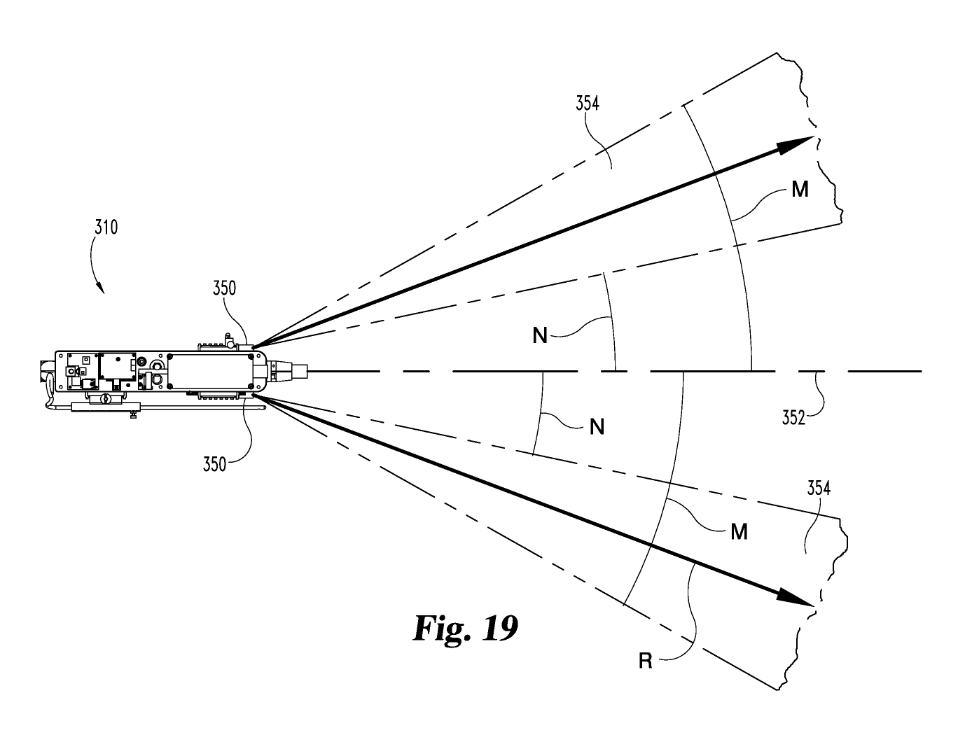

Referring to FIG. 19, the defined sensing area for detectors 350 is illustrated as sensor area 354. Axis 352 is the optical axis of device 310 along which emitted laser energy is directed. Sensor area 354 is the area in which detectors 350 are configured to detect objects. Sensor area 354 is defined by angle N which is the minimum angle between the beginning of sensor area 354 and axis 352 and angle M which is the maximum angle between sensor area 354 and axis 352. Sensor area 354 is also defined by range R which is the maximum distance from detectors 350 that detectors 350 are configured to detect the presence of objects. In one embodiment, angle N is equal to approximately 30 degrees and angle M is equal to approximately 45 degrees and range R is equal to approximately 10 feet.

Detectors 350 are configured as a safety system to prevent someone from walking into the beam emitted by device 310. If detectors 350 detect the presence of an object in sensor area 354, then device 310 is prevented from emitting dazzling laser light. Range R is optimized for a particular device 310 based on the anticipated peripheral vision of the operator while operating device 310. Thus, if device 310 utilizes a scope sighting system, the parameters of sensor 350 may be much different compared to a device 310 utilizing a video display screen for sighting where the operator would be expectant to have better spatial awareness.

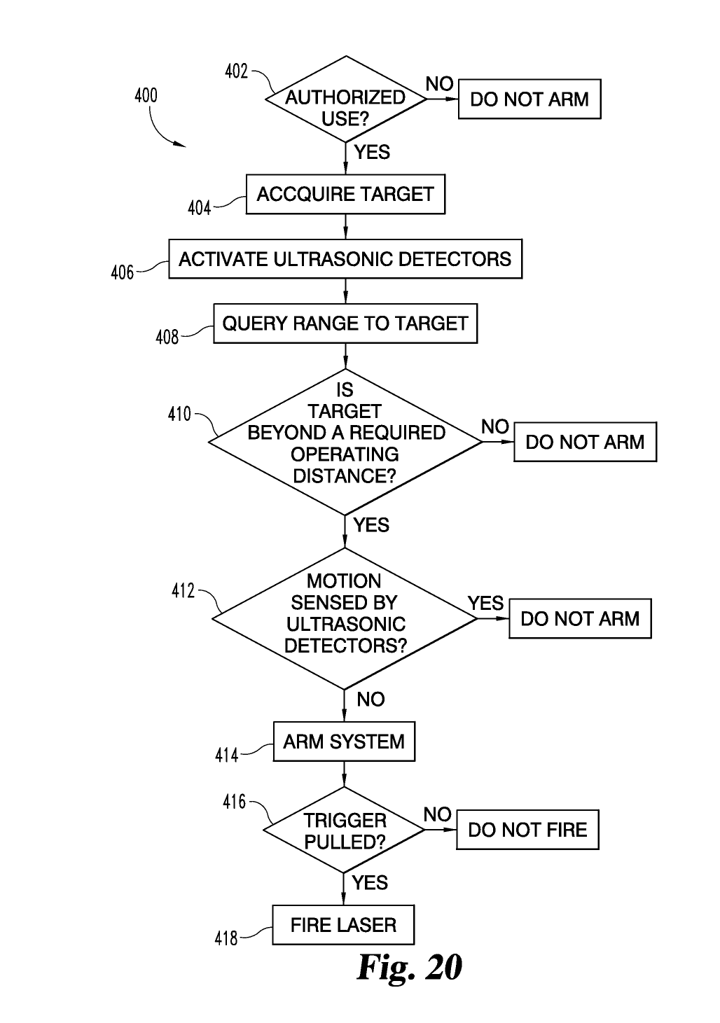

Referring now to FIG. 20, activation procedure 400 is illustrated. Procedure 400 is initiated with step 402 where authorized use is established. This can be in the form of actuating arming switch 137, correctly entering a code on keypad 262, recognition of a biometric scanner, or remote authorization. After use is authorized the operator acquires the target in step 404 and optionally activates ultrasonic detectors 350 in step 406. The range to the acquired target is queried from range finder 127 in step 408.

The controller then compares the determined range to target with a programmed minimum operating distance, for example 300 meters. If the target is determined to be beyond the programmed minimum operating distance, then procedure 400 continues to step 412. If not, then procedure 400 is terminated.

In step 412, the controller determines if ultrasonic detectors 350 have sensed any objects. If not, then procedure 400 continues to step 414. If an object is detected then procedure 400 is terminated. In step 414, the system is armed (ready to be activated). In act 416, the trigger is pulled resulting in firing the laser at the acquired target in step 418.

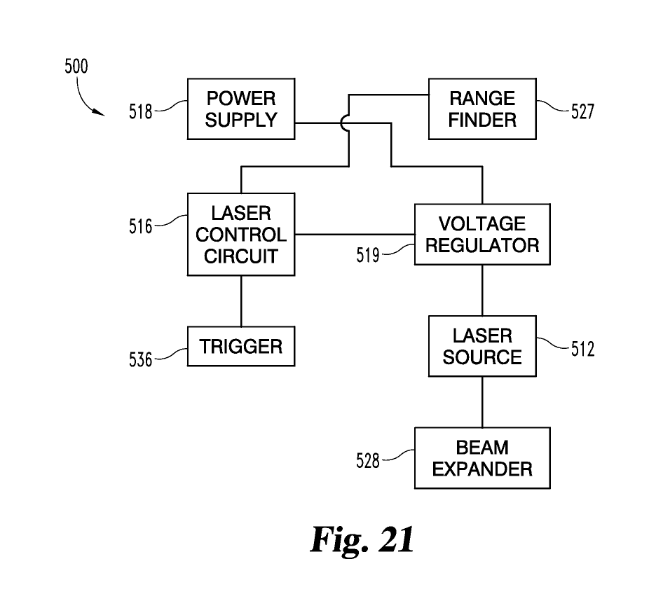

Referring now to FIG. 21, system 500 is illustrated. System 500 is a handheld device similar to device 10 or 100 previously discussed. System 500 includes power supply 518, range finder 527, laser control circuit 516, trigger 536, voltage regulator 519, laser source 512 and beam expander 528. In system 500, laser control circuit 516 controls the voltage to laser source 512 by regulating the voltage to laser source 512 through voltage regulator 519 based on the determined range to the target provided by range finder 527. Laser control circuit 516 then determines the estimated light intensity at the target based on a minimum beam expansion provided by beam expander 528 and the power of laser source 512. This can be accomplished with a look-up table correlating ranges to voltage settings or can be in the form of a variable equation that performs the required calculations. Laser control circuit 516 then regulates the power to laser source 512 so that the light intensity at the target does not exceed the resultant preprogrammed threshold. For example, 2.6 megawatts per cubic square centimeter which has been established as a threshold for eye safety for light at 532 nm.

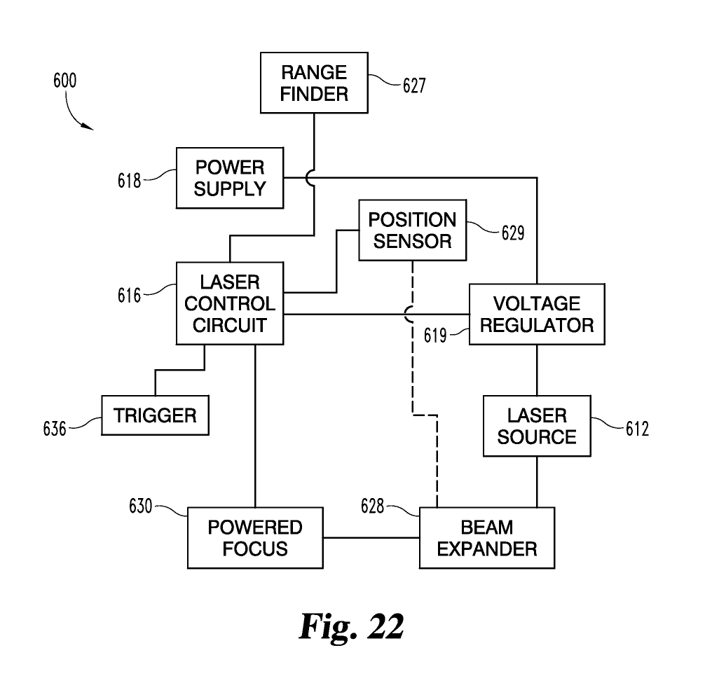

Referring now to FIG. 22, system 600 is illustrated. System 600 includes power supply 618, laser control circuit 616, trigger 636, voltage regulator 619, laser source 612, beam expander 628, powered focus 630, position sensor 629 and range finder 627. In system 600, laser control circuit 616 controls the degree of divergence of beam expander 628 based on the range target determined by range finder 627 and the power output of the laser source 612 to maintain a light intensity at the target below a program threshold. For example, 2.6 megawatts per square centimeter which is a threshold for eye safety for a 532 nm light source. Once again, this can be accomplished by a look-up table correlating ranges with beam expander settings or can be in the form of a calculation.

Position sensor 629 provides relative position information as to the degree of divergence provided by beam expander 628 to laser control circuit 616 and powered focus 630 as a motorized mechanism to rotate beam expander 628 to alter the degree of beam divergence provided by beam expander 628. In addition, voltage regulator 619 may optionally be used to vary the voltage applied to laser source 612 to reduce the effective power output of laser source 612 to further conform the light intensity at the target similar to the operation of system 500 described above.

The devices and system described above can be used in conjunction with providing insurance wherein a ship insurance carrier, for example Lloyds of London, who can provide a discount to ship owners for insurance for equipping a ship or a fleet of ships with a device such a the laser dazzler system and device as described above to provide a passive deterrent to prevent or reduce the occurrences of piracy on a particular ship.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

We claim:

1. A handheld long range dazzling laser comprising:
a laser light source with at least 1 Watt output;
a focus-adjustable beam expander;
a power source;
a trigger; and
a magnifying targeting device.

2. The handheld long range dazzling laser of claim 1, further comprising a rangefinder.

3. The handheld long range dazzling laser of claim 2, further comprising a controller and a voltage regulator, wherein the controller varies the voltage supplied to the laser light source from the power source based at least in part on a range determined by the rangefinder.

4. The handheld long range dazzling laser of claim 2, further comprising a motorized focus adjustment for the focus-adjustable beam expander and a controller, wherein the controller varies the divergence of the beam expander based at least in part on a range determined by the rangefinder.

5. The handheld long range dazzling laser of claim 2, further comprising a controller, a voltage regulator and a motorized focus adjustment for the focus-adjustable beam expander, wherein the controller varies both the divergence of the beam expander and the voltage supplied to the laser light source from the power source based at least in part on a range determined by the rangefinder.

6. The handheld long range dazzling laser of claim 1, wherein the laser light source has at least a 3 Watt output.

7. The handheld long range dazzling laser of claim 1, further comprising a hand grip and a stock, wherein the trigger is positioned proximate the hand grip.

8. The handheld long range dazzling laser of claim 1, further comprising detectors angled from the optical axis of the laser light source configured to detect the presence of objects within a defined area.

9. The handheld long range dazzling laser of claim 8, wherein the defined area is between approximately 30 degrees and approximately 45 degrees from the optical axis of the laser light source.

10. The handheld long range dazzling laser of claim 1, further comprising a keypad constructed and arranged to prevent activation of the long range dazzling laser until entry and acceptance of a preprogrammed activation code.

11. The handheld long range dazzling laser of claim 3, further comprising a keypad constructed and arranged to prevent activation of the long range dazzling laser until entry and acceptance of a preprogrammed activation code.

12. The handheld long range dazzling laser of claim 1, further comprising a biometric scanner constructed and arranged to prevent activation of the long range dazzling laser until acceptance of a preprogrammed biometric reading.

13. The handheld long range dazzling laser of claim 3, further comprising a biometric scanner constructed and arranged to prevent activation of the long range dazzling laser until acceptance of a preprogrammed biometric reading.

14. The handheld long range dazzling laser of claim 1, further comprising an authorization switch constructed and arranged to be located remotely from the long range dazzling laser wherein the long range dazzling laser is only activated by the authorization switch.

15. The handheld long range dazzling laser of claim 3, further comprising an authorization switch constructed and arranged to be located remotely from the long range dazzling laser wherein the long range dazzling laser is only activated by the authorization switch.

16. The handheld long range dazzling laser of claim 14, wherein the magnifying targeting device comprises a video camera with a remote video feed.

17. The handheld long range dazzling laser of claim 15, wherein the magnifying targeting device comprises a video camera with a remote video feed.

18. The handheld long range dazzling laser of claim 1, wherein the magnifying targeting device comprises a video camera and a video data storage apparatus and wherein the video camera is configured and arranged to store recorded video any time the long range dazzling laser is activated.

19. The handheld long range dazzling laser of claim 3, wherein the magnifying targeting device comprises a video camera and a video data storage apparatus and wherein the vide camera is configured and arranged to store recorded video any time the long range dazzling laser is activated.

20. A method comprising:
discounting a ship's insurance rates when the ship is equipped with a handheld long range dazzling laser comprising: a laser light source with at least 1 Watt output; a focus-adjustable beam expander; a power source; a trigger; and a magnifying targeting device.
